(19) United States
(12) Patent Application Publication
(10) Pub. No.: US 2007/0080947 A1
(43) Pub. Date: Apr. 12, 2007

(54) Bartender's buddy

(76) Inventor: James M. Rau, St. Louis, MO (US)

Correspondence Address: Raymond M. Galasso;Galasso & Associates LP, P.O. Box 26503, Austin, TX, 78755-0503, US

(21) Appl. No.: 11/246,326

(22) Filed: Oct. 6, 2005

(51) Int. Cl. G09G 5/00

(52) U.S. Cl. 345/169

(57) ABSTRACT

The Bartender's Buddy is an electronic bartender's guide that allows the user easy access to a variety of mixed drink recipes. The Bartender's Buddy is comprised of a small housing, a plurality of buttons, an electronic display and contains at least a circuit board and an internal memory. A user operates this guide by simply turning on the device, pressing a control key and typing either the full name or a portion of the name of a mixed drink. The ingredients of the mixed drink are then displayed next to the name of the drink.

### CROSS REFERENCE TO RELATED APPLICATIONS

This Non-Provisional Patent Application does not claim priority to any U.S. Provisional Application or foreign patent application.

### FIELD OF THE DISCLOSURE

The disclosures made herein relate generally to bar contraptions and devices. The invention discussed herein is in the general classification of bartender's guides.

### BACKGROUND

Alcoholic beverage consumers have a variety of choices including wines, beers, mixed drinks, and other spirits. Mixed drinks are typically concocted from a multitude of ingredients, such as fruit juices, sodas, spirits and a variety of other beverages. Many mixed drinks and shots have long and complicated recipes. A bartender or beverage maker can have difficulty remembering all of the ingredients for a drink, especially if he is preparing a number of different drinks at one time.

A variety of bar tending guides have been used in the past to address this problem. However, these guides suffer from a variety of drawbacks. For example, bound paper bar guides are often cumbersome to handle and can be destroyed or damaged when they come into contact with the various beverages at a bar. They also can be too voluminous and bulky for easy reference.

In addition, various reel style or rotary bar guides have been invented that can also provide a bartender with the necessary information to make various mixed drinks and shots. These devices also can be difficult to operate quickly and often have a limited amount of space on the reels. Consequently, the number of mixed drink recipes listed is often limited.

### SUMMARY OF THE DISCLOSURE

In general, The Bartender's Buddy allows a bartender to turn the device on, type in the name or part of the name of a drink, and follow a recipe that is displayed corresponding with the drink requested.

In one embodiment of the invention, The Bartender's Buddy includes a small, roughly rectangular housing with rounded edges. The housing would be equipped with at least a circuit board, an internal memory, a plurality of buttons and an electronic display screen.

Although the device described herein is often referred to as a bar device, it should be understood that such a device could be used to store recipes or any other type of suitable information.

The principal object of this invention is to provide an electronic guide that allows the user to quickly and easily look up the recipe for a mixed drink or shot.

Another object of the invention is to provide a waterproof compartment for the electronic guide.

Yet another object of the invention is to provide a durable electronic guide that can be easily stored and uses only a small amount of counter or bar top space.

### BRIEF DESCRIPTION OF THE DRAWINGS

FIG. 1 depicts a perspective view of the preferred embodiment of the invention.

FIG. 2 depicts a rear view of the preferred embodiment of the invention.

### DETAILED DESCRIPTION OF THE DRAWINGS

The Bartender's Buddy of the present invention is comprised of at least some of the following: a housing containing at least a circuit board and an internal memory and including a plurality of buttons and an electronic display screen. The Bartender's Buddy may also include a battery compartment with metal contacts, rubber grips, a glass or plastic cover, and a light bulb to illuminate the display screen.

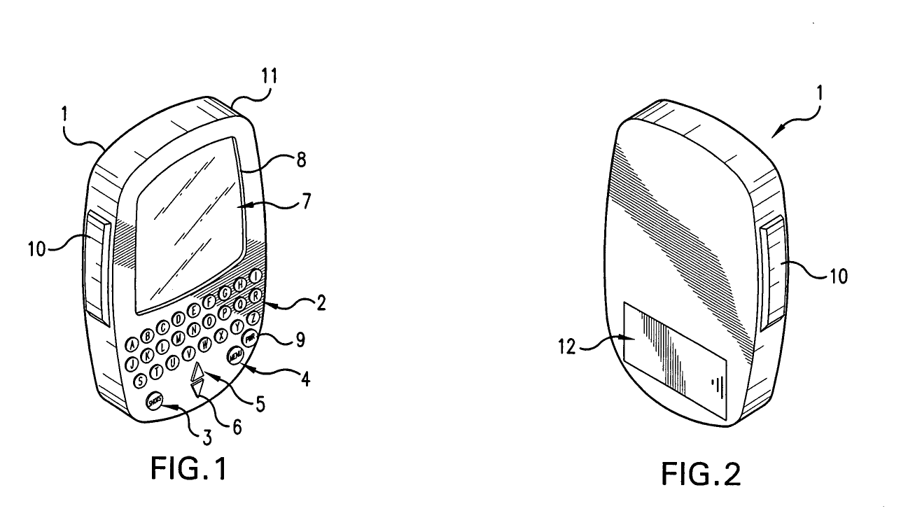

In the preferred embodiment of the invention, shown in FIG. 1, a small, roughly rectangular plastic housing 1 with rounded edges 11 encases a circuit board (not shown) and internal memory (not shown). In this embodiment, the housing 1 measures six (6) inches in length, four (4) inches in width, and half (½) an inch in thickness. The housing 1 has a series of alphanumeric keys 2, a Shots key 3, a Menu key 4, a triangular shaped up arrow key 5 and a triangular shaped down arrow key 6, all protruding through the front of the housing 1. The Shots key 3 and the Menu key 4 are function or control keys.

The plastic housing 1 also encases a display screen 7 with a glass cover 8 and a light bulb (not shown) used to illuminate the display screen 7. The alphanumeric keys 2, Shots key 3, Menu key 4, triangular shaped up arrow key 5, and triangular shaped down arrow key 6 are all backlit to permit easy viewing in the darkness. All of these keys are also made of rubber in the preferred embodiment shown in FIG. 1.

A power button 9 also protrudes through the front of the housing 1 and is made of rubber and backlit. The power button 9 allows a user to turn the device on and off. Rubber grips 10 on both sides of the housing permit the user easy handling of the device.

FIG. 2 shows the rear view of the preferred embodiment of the invention wherein the plastic housing 1 has a battery compartment 12 with metal contacts (not shown) inside the battery compartment 12. A rubber grip 10 is also visible in this rear view.

The Bartender's Buddy is designed to operate in a variety of ways. It allows the bartender to turn the device on using the power button, press the Shots key and type in the full name of the mixed drink or shot using the alphanumeric keys. When the full name is typed into the device, the user then presses the Shots key again. The ingredients of the requested mixed drink or shot are then displayed. The user can then simply follow the recipe that is displayed.

Alternatively, the user can simply turn the device on using the power button, push the Menu key and then type in the first letter or a portion of the name of the mixed drink or shot using the alphanumeric keys. The user can then use the up arrow key or down arrow key to scroll through the menu to the desired drink and press the Menu key again when the desired drink is reached. The user then follows the appropriate recipe displayed. Obviously, the buttons can also be used in a variety of other ways to operate the device without departing from the spirit of this invention.

The Bartender's Buddy will be offered in a variety of sizes and colors. It should be understood that a variety of function keys, and control keys could be used with the invention described herein. The components of The Bartender's Buddy may vary widely but will likely utilize electrical components, metal components, rubber and plastic.

Ideally, the Bartender's Buddy is constructed of the best quality materials commonly accepted and used in the manufacturing industry today. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

Plastic may be used in the production process of the Bartender's Buddy. The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of The Bartender's Buddy can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An electronic guide comprising:
(a) a housing encasing a circuit board and an internal memory for storing a plurality of recipes;
(b) a plurality of alphanumeric keys protruding through the front of the housing;
(c) at least one control key protruding through the front of the housing;
(d) an up arrow key and a down arrow key protruding through the front of the housing;
(e) a display screen encased in the housing; and
(f) a battery compartment located on the housing.

2. The electronic guide of claim 1 wherein the housing is constructed of a waterproof material.

3. The electronic guide of claim 1 wherein the housing is constructed of plastic.

4. The electronic guide of claim 1 wherein the housing has rounded edges.

5. The electronic guide of claim 1 wherein the housing is approximately rectangular in shape.

6. The electronic guide of claim 1 wherein the control key, the up arrow key, the down arrow key, and the plurality of alphanumeric keys are made of rubber.

7. The electronic guide of claim 1 wherein the up arrow key and the down arrow key are approximately triangular in shape.

8. The electronic guide of claim 1 further comprising
a cover over the display screen.

9. The electronic guide of claim 1 further comprising
a light bulb inside the housing to illuminate the display screen.

10. The electronic guide of claim 1 further comprising
at least one rubber grip on the side of the housing.

11. The electronic guide of claim 1 further comprising
a power button protruding through the housing.

12. The electronic guide of claim 1 further comprising
a power switch located on the side of the housing.

13. The electronic guide of claim 1 wherein the control key, the up arrow key, the down arrow key and the plurality of alphanumeric keys are backlit.

14. The electronic guide of claim 1 wherein the battery compartment is located on the rear of the housing.

15. An electronic guide comprising:
(a) a housing made of plastic and roughly rectangular in shape with roughly rounded edges that encases a circuit board and an internal memory capable of storing a plurality of drink recipes;
(b) a plurality of alphanumeric keys made of rubber and backlit that protrude through the front of the housing;
(c) a first control key made of rubber and backlit that protrudes through the front of the housing and a second control key made of rubber and backlit that protrudes through the front of the housing;
(d) an up arrow key that is approximately triangular in shape, backlit and made of rubber that protrudes through the front of the housing and a down arrow key that is approximately triangular in shape, backlit and made of rubber that protrudes through the front of the housing;
(e) a display screen illuminated by a light bulb and encased in the housing and overlaid by a glass cover;
(f) a battery compartment located on the rear of the housing;
(g) a first rubber grip located on a first side of the housing and a second rubber grip located on a second side of the housing; and
(h) a power button protruding through the front of the housing.
